(19) United States
(12) Patent Application Publication
(10) Pub. No.: US 2013/0065642 A1
(43) Pub. Date: Mar. 14, 2013

(54) LUMINAIRE CONTROL SYSTEM AND METHOD FOR WIRELESSLY CONTROLLING THE SAME

(71) Applicant: CHIA-CHI LIU, TAIPEI CITY (TW)

(72) Inventor: CHIA-CHI LIU, TAIPEI CITY (TW)

(73) Assignee: LUSTROUS GREEN TECHNOLOGY OF LIGHTING, NEW TAIPEI CITY (TW)

(21) Appl. No.: 13/229,854

(22) Filed: Sep. 12, 2011

(51) Int. Cl. H04W 88/00; G08C 19/16

(52) U.S. Cl. 455/557; 340/12.5

(57) ABSTRACT

Disclosed herein are a luminaire control system and a method for wirelessly controlling the same. In which, the luminaire is capable of communication protocol translation, and being able to be wirelessly controlled by a remote control over a communication network. Furthermore, a user interface accompanied with an application is installed to the remote control to provide user interface for controlling the luminaire. The user interface displays functions to be selected including switching on or off the luminaire, changing colors, adjusting luminosity, controlling frequency of flashing, dimming and transition of the functions. In response to the input signals generated by the remote control, the luminaire is controlled for performing operations, accordingly

### BACKGROUND OF THE INVENTION

1. Field of the Invention

The invention relates to a luminaire control system and a method for wirelessly controlling the luminaire, in particular, the luminaire is controllable through a wireless communication technology performed by a communication device.

2. Description of Related Art

Recent technological advancements in the light-emitting diode (LED) designs have been developed in the lighting industry. With their high overall luminous efficacy and flexibility in achieving various light patterns, LED-based luminaires are increasingly being used in the applications including architectural, entertainment, roadway lighting, home luminaire, signage, advertising, display lighting, and backlit lighting. Furthermore, LED-based luminaires are becoming the mainstream light source and gradually replacing the traditional incandescent or fluorescent lighting fixtures according to the current lighting industry development.

Also, some conventional technologies have been developed for the purpose of controlling illuminations of light-emitting devices, for example the light-emitting diodes (LEDs). The well-controlled means further advances the light-emitting diodes to become increasingly-competitive with light sources such as incandescent, fluorescent, and high-intensity discharge lamps.

One of the challenges in using the light-emitting diodes as the light source for the luminaire is to design a system that can set and maintain the intensity and the chromaticity of the mixed light emitted by a plurality of colors, for example, blue and yellow or red, green, and blue LEDs. The light emitted by those light-emitting diodes may vary depending on the operating conditions other than the electrical currents supplied to the LEDs.

In current technologies, the system for controlling the luminaire preferably using the light-emitting diodes adopts a circuit board embedded in the luminaire or a connected control box. The related controller may provide various options for modulating the luminous operations. Traditionally, buttons may be installed for electrically linking to the internal control circuits and provided for users to manipulate various luminous functions.

Thus the detailed description directed to the invention is disclosed to provide a solution to the problem.

### SUMMARY OF THE INVENTION

For efficiently controlling the luminaire, particularly the devices made by LEDs, the instant disclosure discloses a luminaire control system and a method for wirelessly controlling the same. A remote control is particularly incorporated into the system for communicating with the luminaire which is capable of translating a specific communication protocol.

One of the objectives of the present invention is to provide a luminaire control system. This system exemplarily includes a lighting device, for example a luminaire adopts a plurality of LEDs as a light source. The lighting device includes a lighting unit having the light source, a micro-processing unit linking with a memory unit for interpreting signals, and a controlling unit for receiving signals interpreted by the micro-processing unit and generating one or more control signals to the lighting unit for performing operations. Furthermore, the lighting device particularly includes a communication unit for translating communication packets received through a wireless transceiver and an antenna over a communication network. The lighting device further includes a power unit for supplying power to the components in the device.

Furthermore, a remote control is included in the system, and a user interface accompanied with an application installed therein is used to interfacing the lighting device. The remote control is able to connect with the lighting device which is capable of wireless communication. Over a specific communication network, the remote control sends input signals to the lighting device for performing device operations.

In one further aspect of the invention, one of the objectives is to provide a method for wirelessly controlling the lighting device. The method is performed by having the remote control executing the application installed therein through the generated user interface.

The method primarily includes an initialization process between the luminaire and the remote control, and a control process directed to the lighting device. The initialization process includes a first step of powering on the lighting device. Further, a step in the method is to initialize a control process of the lighting device to be ready for remote control. After that, a communication between the lighting device and the remote control is initialized. The initialization process includes performing a frequency matching process and a process of negotiation which dynamically sets parameters of the communication channel established there-between.

In the control process directed to the lighting device, the lighting device receives the control signals over the mentioned communication network, and processes the signals for performing operations. The control signals are transferred from the input signals generated by the remote control, and further interpreted as one or more control commands to the lighting device.

In another aspect of the invention, a method for wirelessly controlling a luminaire is disclosed. The luminaire is capable of a communication protocol translation. The method in the beginning includes initializing the luminaire, initializing a remote control, and establishing a communication channel between the luminaire and the remote control. The remote control generates the input signals as the communication channel to the luminaire is established. Next, the luminaire interprets the input signals and generates control signals, accordingly. Then the control signals are processed and consequently, the luminaire is controlled for performing operations in response to the control signals.

### BRIEF DESCRIPTION OF THE DRAWINGS

FIG. 1 schematically illustrates a communication way established between a luminaire and a remote control in accordance with the present invention;

FIG. 2 shows a block diagram illustrating an embodiment of a lighting device in accordance with the present invention;

FIG. 3 shows a schematic diagram illustrating one embodiment of a luminaire control system in accordance with the present invention;

FIG. 4 shows a diagram of one remote control establishing various communication channels with different lighting devices in one embodiment of the present invention;

FIG. 5 exemplarily describes a method for wirelessly controlling a lighting device according to the present invention;

FIG. 6 exemplarily describes a method for wireless controlling a lighting device in a system of the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

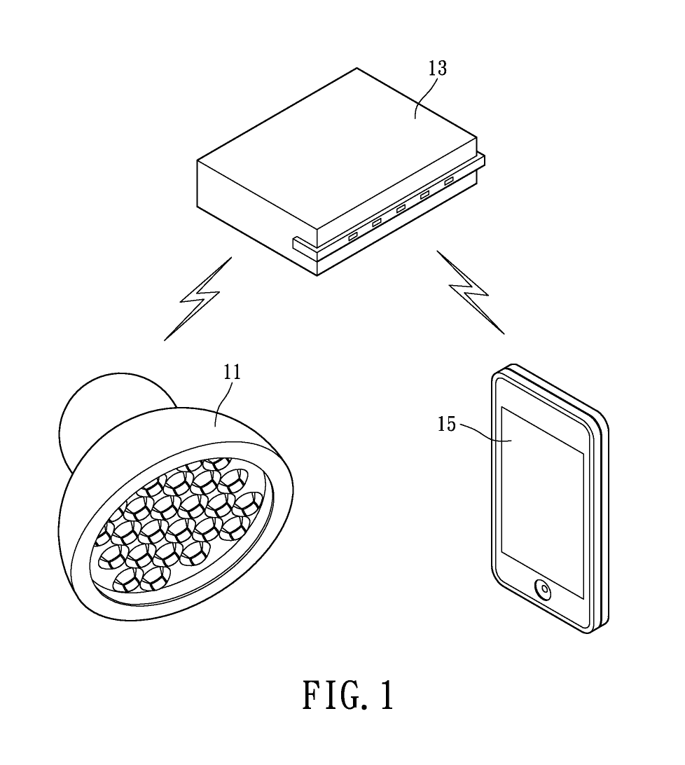

Reference is made to FIG. 1, which schematically illustrates an exemplary communication way established between a luminaire and a remote control in accordance with the present invention.

One of the objectives of the instant disclosure is to provide a shown lighting device 11 which is capable to establish a wireless communication path to implement a scheme of remote control. In FIG. 1, the lighting device may be implemented as a luminaire, which is made of a light emitting module consisting of plural types of LEDs capable of emitting lights in different colors. Generally, the LEDs form an array and serve as a light source for the luminaire to be a lighting lamp. Further, a controller shall be prepared for controlling electric current fed to each of the LEDs.

The lighting device 11 is capable of processing a specific communication protocol translation, such as WiFi™, Bluetooth™, long-term evolution (LTE), GSM, 3G/3.5G, WiMax™, ZigBee™, and the like. A shown wireless station 13 is used to function as a base station, an access point or a gateway for bridging the communication signals between the lighting device and a remote control 15.

According to an aspect of the instant disclosure, the remote control 15 is preferably a handheld device having a display screen for displaying the control items. For example, the remote control 15 may generate a user interface for users to manipulate operations of the lighting device 11. The user interface is preferably generated by an application executed by a processor (not shown) in the remote control 15.

For instance, a mobile phone may be the remote control 15, and can install a remote control program which may generate the user interface providing the control items. Further, the remote control program may be an application downloaded from a server over a mobile communication network. The mobile phone can thereby generate an input signal as a user clicks one of the control items.

Since the input signal is generated and then transmitted to the lighting device 11 through the wireless station 13 by means of a specified communication protocol supported by both lighting device 11 and the remote control 15, the lighting device 11 may operate in response to the signal interpreted by the processor.

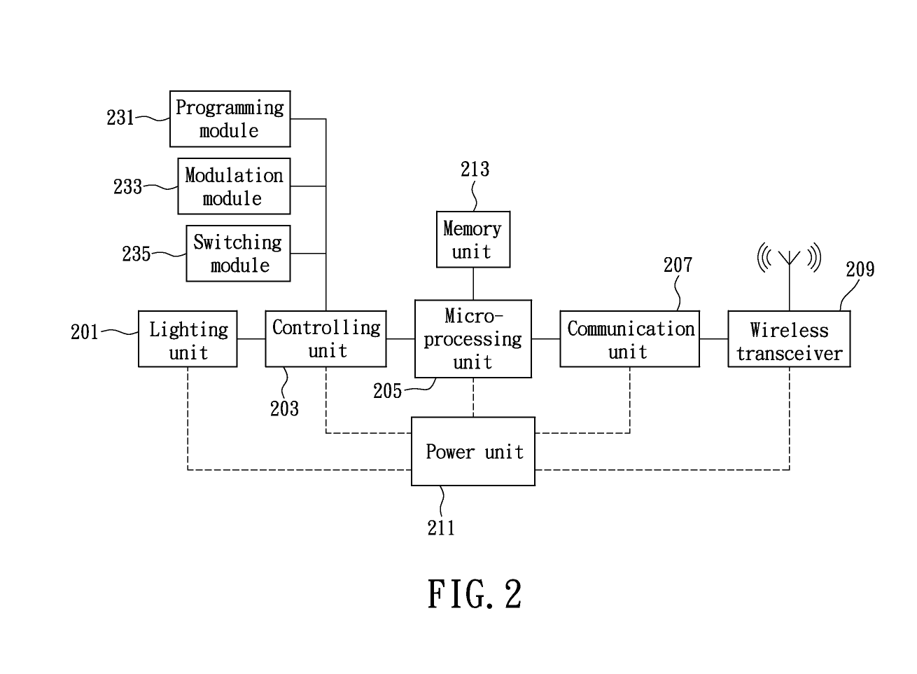

FIG. 2 next shows a block diagram illustrating an embodiment of a lighting device in accordance with the present invention.

The mentioned lighting device is a luminaire primarily including a lighting unit 201 exemplarily made of a plurality light-emitting diodes (LEDs) which are in combination of at least two of a red LED, a green LED, and a blue LED, yet still not exclude other programmable lighting components. The light device includes a controlling unit 203 electrically connected to the lighting unit 201 and a micro-processing unit 205 for interpreting the received signals and then generating one or more control signals to the lighting unit 201 for further operations. The controlling unit 203 is in charge of driving the lighting unit 201 to configure lighting in response to the interpretation of control signals. In the controlling unit 203, a programming module 231, a modulation module 233, and a switching module 235 may be introduced based on the functionalities the lighting device provides.

The micro-processing unit 205 included in the lighting device is for processing data transmission/reception based on a predetermined scenario, especially for interpreting the input signals. A memory unit 213 is further provided for storing and buffering the data processed in the lighting device. The memory unit 213 is generally linked with the micro-processing unit 205.

According to an exemplary example of the controlling unit 203, the programming module 231 serves the lighting device able to be programmable. The functions which include various lighting effects provided for the lighting device are programmable through the programming module 231 in the controlling unit. For example, the user may operate the remote control to program the functions for the lighting unit 201, especially the functions configured to be programmed through the user interface generated by the application in the remote control.

Furthermore, the modulation scheme directed to the lighting unit 201 configured by the modulation module 233 is to drive the lighting device to perform one or more functions, such as changing color, adjusting luminosity, controlling frequency of flashing, dimming, and transition of the functions, further include angle of the luminaire and timing for the transition. The modulation module 233 serves the lighting device able to perform the various lighting effects in response to the control signals interpreted by the micro-processing unit 205. The control signals are served to modulating the lighting device by the modulation module 233 in the controlling unit 203. Generally, the described modulation scheme is implemented by the modulation module 233 through controlling the input current, frequency range, and pulse width to each of the LEDs or other like light source in the lighting unit 201.

The switching module 235 can be introduced for users to manipulate the operations based on the functionalities which the lighting device provides. Other than the traditional technologies that employ buttons being installed to electrically link to the internal control circuits. Moreover, the provided switching module 235 is to generate the switching signal, preferably on (1) and off (0), according to the control signal interpreted by the micro-processing unit 205. The related control signal generated by translating the input signal from the remote control is directed to drive the switching module 235 to switching the lighting device on or off.

In an exemplary example, when a switching signal represents a signal of turning on the lighting unit 201, the controlling unit 203 may output a driving current which turns on each or groups of LEDs or the like. Similarly, when the switching signal directs to turning off the lighting unit 201, the controlling unit 203 may output a driving current for turning off each or group of the LEDs or the like. Some further lighting effects may also be included into this scheme, such as flashing, changing colors, regulating brightness, and dimming for the LEDs.

Furthermore, the lighting device includes a communication unit 207 electrically connected with the micro-processing unit 205. The lighting device is able to render the communication signals indicating that the communication unit 207 is functional. Therefore, the lighting device is capable of processing one or more specified communication protocol translations. The described remote control is operatively linked with the lighting device over a specific communication network. Both the remote control and the lighting device are required to be in compliance with the same communication protocol.

The lighting device is further equipped with a wireless transceiver 209 which is connected with the communication unit 207. The communication unit 207 is adopted for processing communication packets received through the wireless transceiver 209 and an antenna over the communication network. The wireless transceiver 209 is used to transmit and receive the packets between the remote control and the lighting device via the antenna in accordance to the embodiment of the present invention.

A power unit 211 is for powering the components of the lighting device, including supplying power to the LEDs of the lighting unit 201.

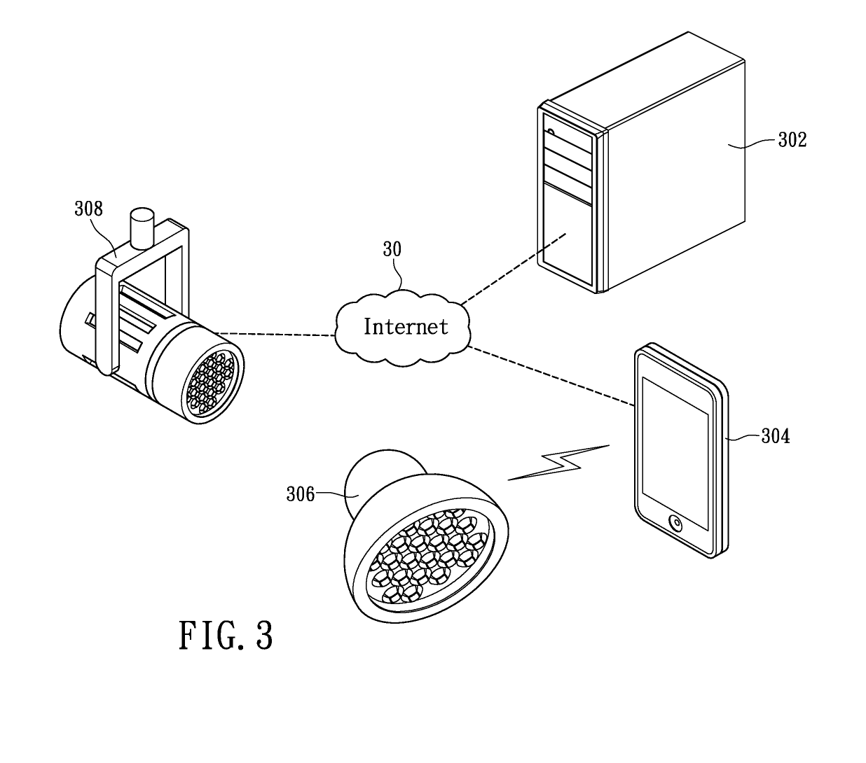

FIG. 3 further shows a schematic diagram illustrating one embodiment of a luminaire control system in accordance with the present invention. According to this embodiment, the luminaire control system may be implemented locally since the remote control 304 can be communicated with a lighting device 306 within the same space. Furthermore, the luminaire control system may also be embodied over an Internet 30, and the described lighting device (308) may be controlled in response to the signals delivered over the Internet 30.

It is worth to note that a remote control 304 may link with the lighting device 306 wirelessly. The wireless station 13 shown in FIG. 1 may be incorporated into this scheme for bridging the signals there-between. For example, WiFi™, Bluetooth™, and ZigBee™ communication technologies may be used for this scenario. In which, WiFi™ is a wireless standard for connecting electronic devices, such as the luminaire (for example, the lighting device 306) in accordance with the present invention. A Wi-Fi enabled device, such as the remote control 304, can connect to the lighting device 306 within a specified range of radio frequency. Further, Bluetooth™ is a proprietary open wireless technology standard for exchanging data over a short distance, for example between the remote control 304 and the lighting device 306. Bluetooth™ is advantaged as it provides high level of security.

In particular, ZigBee™ is a preferred scheme for implementing the luminaire control system in accordance with the present invention. ZigBee™ is a specification for a suite of high level communication protocols utilizing small, low-power digital radios based on the IEEE 802.15.4-2003 standard and thereby suitable for wireless light switches with lamps, electrical meters with in-home-displays, consumer electronic equipment via short-range radio requiring low data transfer rates. Further, ZigBee™ protocol is featured in that it supports for multiple network topologies such as point-to-point, point-to-multipoint and mesh networks.

Moreover, in one embodiment of the present invention, the remote control 304 may be implemented by a mobile phone or any handheld computer-enable device. In this approach, the mobile phone may first download a remote control application from a server 302 or other providers over Internet 30. Such as the prevalent smart phone, as the smart phone is able to install third party program from the provider. By the remote control application, the remote control 304 can establish a proprietary communication channel to the luminaire (the lighting device 306 or 308) and enable the luminaire to be controlled. The remote control application in accordance with one of the embodiments of the invention may generate a user interface for users to manipulate the operations to the luminaire. The user interface allows users to generate the input signals for the lighting device (306, 308) over a communication network.

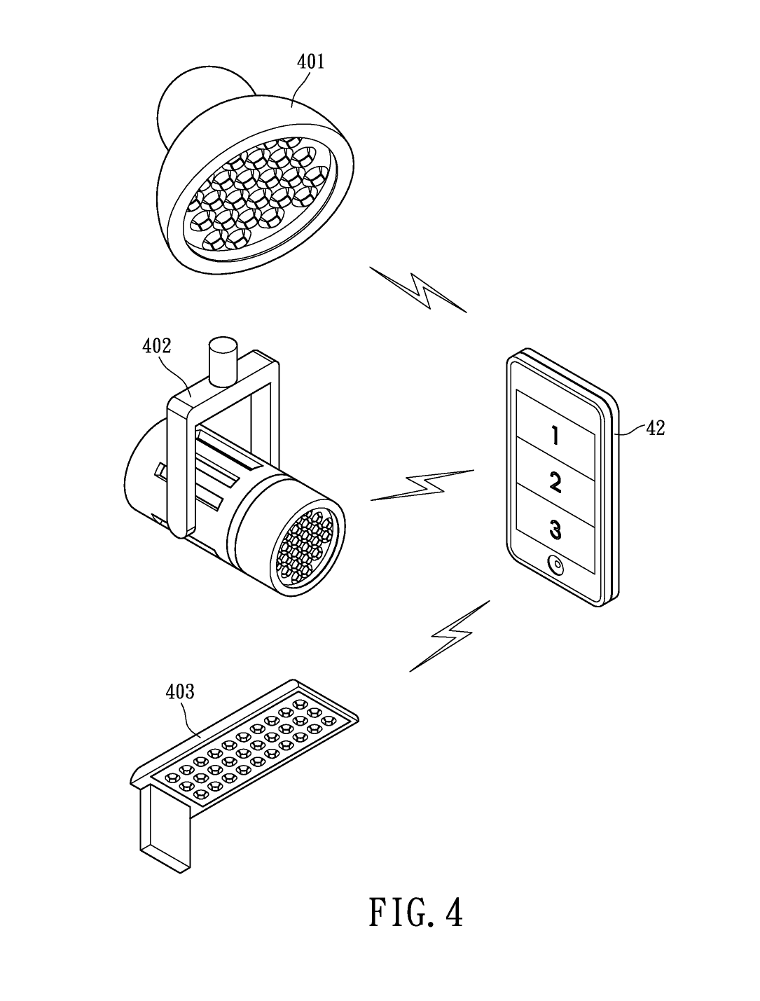

Reference is made to FIG. 4, which shows a diagram of one remote control establishing various communication channels with different lighting devices in one embodiment of the present invention. According to one of the embodiments of the invention, the remote control is capable of connecting more than one lighting devices through more than one communication channels at same time.

In FIG. 4, the remote control 42 is installed with a remote control application for wirelessly controlling multiple lighting devices. The remote control 42, in this example, is capable of establishing multiple communication channels to link with a first lighting device 401, a second lighting device 402, and a third lighting device 403. The related remote control application also generates a user interface provided for users to manipulate operations to the multiple devices 401, 402, 403. For example, the screen of the remote control 42 is divided into three split portions which are corresponding to the lighting device 401, 402 and 403, individually.

The remote control application allows the user to control multiple lighting devices (401, 402, and 403). In an exemplary example, the remote control application creates three virtual drivers for the multiple lighting devices to be controlled when the user inputs the related instruction. The scheme implies that the remote control may alone send a control signal to one of the lighting devices, as well as simultaneously generates a control signal to all of the lighting devices 401, 402, and 403. That is, the control signal may be directed to a corresponding device, or to more than one device.

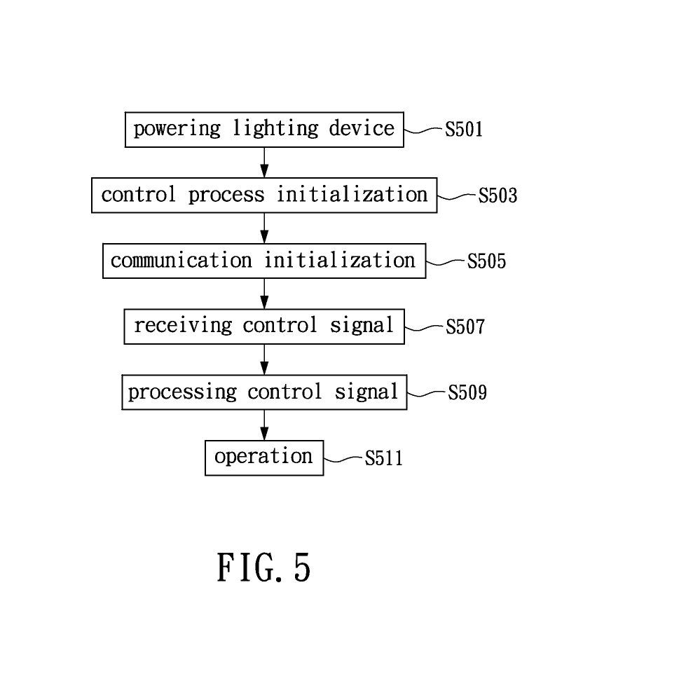

Based on the above described luminaire control system, reference is further made to FIG. 5 which exemplarily describes the method for wirelessly controlling the lighting device according to the present invention. The method mainly performs an initialization process between the luminaire and the remote control and a control process directed to the luminaire.

The exemplary initialization process is provided as follows.

In the beginning, such as step S501, one or more lighting devices are powered on, and immediately perform control process initialization (step S503). For one or more lighting devices to be controlled, each lighting device is required to be ready for remote controlling made by the remote control. Based on a specific communication protocol, the lighting device is standby for listening to any signal sent from the remote control.

When both remote control and the lighting device are ready, a communication initialization is in process (step S505). In the process of communication initialization, a handshaking procedure for verifying the communication between the remote control and the lighting device may be processed. The handshaking procedure exemplarily includes performing a frequency matching process and a process of negotiation that dynamically sets parameters of a communication channel established there-between. The communication channel between the remote control and the lighting device is established as the communication there-between has been verified. In an exemplary example, the remote control application provides a function of sending request and acknowledgement packets to one or more lighting devices. The communication may be verified by checking whether or not the remote control receives the response packet from one or more lighting devices. The communication channel to the specified lighting device (its communication unit) is established once the remote control transmits an acknowledgement packet to the lighting device after receiving the response.

The exemplary control process in is provided as follows:

After the communication initialization has been done, the user may use the remote control to input instruction to control the lighting device (step S507). In particular, a user interface generated by the application in the remote control is employed to execute the input instruction. The remote control then sends the input signals to the designated lighting device over the established communication channel after pre-processing the instruction. The communication unit in the lighting device may then translate the communication packets. When the lighting device receives the input signals, the processor in the lighting device interprets the signals and generates the control signals, correspondingly. The control signals may be interpreted as one or more control commands to the lighting device (the luminaire) for performing further operations. The controlling unit in the lighting device processes the control signals (step S509) and drives the lighting unit to operate the corresponding function(s) in response to the control commands (step S511).

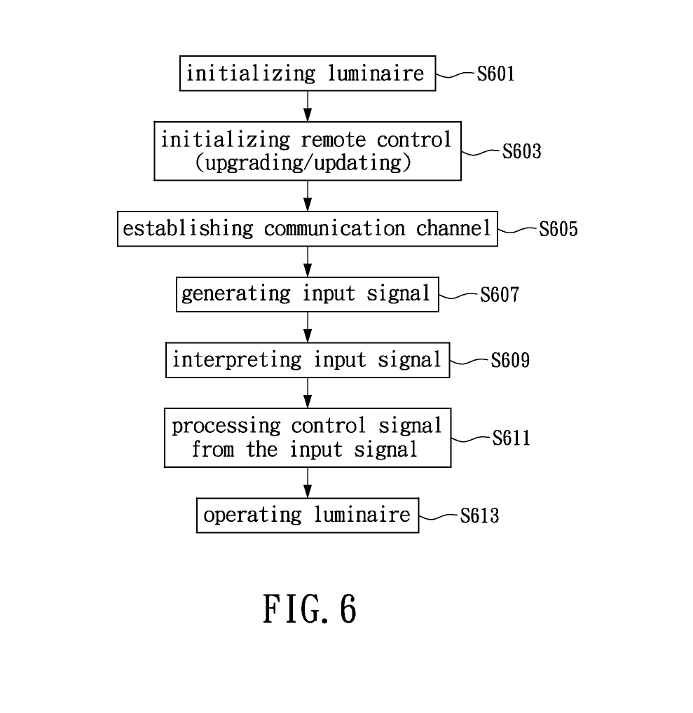

In another aspect of the present invention shown in FIG. 6, a method for wireless controlling lighting device in a system is exemplarily described.

The step S601 in the method serves to initialize the lighting device, including powering on the lighting device and standby to listen to the control signals. The step S603 in the method serves to initialize the remote control to be in a ready state. In an example, when the remote control application is executed in the remote control, the application may be notified for upgrading or updating from Internet or any other sources.

After the initializations for both lighting device and remote control have been completed, a communication channel is established between the lighting device and the remote control to process the necessary connection process (step S605).

In step S607, the input signals are generated by the remote control and transmitted to the lighting device over the communication channel. The input signals are received by the lighting device and interpreted to be the control signals by the processor (step S609). The lighting device then processes the control signals (step S611). After that, the lighting device is controlled for performing operations in response to the control signals (step S613).

To sum up the above description, the instant disclosure discloses a wireless control mechanism provided for one or more luminaires. A remote control is prepared for controlling the luminaire through an application which generates a user interface for manipulations. A human-machine interface over a communication network is thereby well established.

It is intended that the specification and depicted embodiment be considered exemplary only, with a true scope and spirit of the invention being indicated by the broad meaning of the following claims.

1. A luminaire control system, comprising:
a lighting device, including:
a lighting unit composed of a plurality of light-emitting diodes;
a micro-processing unit linking with a memory unit for interpreting signals;
a controlling unit including a modulation module, electrically connected with the lighting unit and the micro-processing unit, for receiving signals interpreted by the micro-processing unit and generating one or more control signals to the lighting unit for performing operations; and, the one or more control signals are configured to control input current, frequency range, or/and pulse width for each or group of light-emitting diodes in the lighting unit of the lighting device by the modulation module;
a communication unit, electrically connected with the micro-processing unit, for translating communication packets received through a wireless transceiver and an antenna over a communication network;
a power unit for powering the lighting device;
a mobile phone providing a user interface generated by an application installed in the mobile phone, linking with the lighting device over the communication network, for generating input signals so as to control the lighting device using the user interface; and
a wireless communication means for establishing a communication channel between the lighting device and the mobile phone through a wireless station.

2. The luminaire control system of claim 1, wherein the lighting unit is made of a plurality of light-emitting diodes which are in combination of at least two of a red LED, a green LED, and a blue LED.

3. The luminaire control system of claim 1, wherein the control signal is directed to process switching on or off the lighting device by a switching module in the controlling unit.

4. The luminaire control system of claim 3, wherein the switching module interprets the control signal as a switching signal.

5. (canceled)

6. (canceled)

7. The luminaire control system of claim 1, wherein the modulation made by the modulation module is to drive the lighting device to perform one or more functions including changing colors, adjusting luminosity, controlling frequency of flashing, dimming and transition of the functions.

8. The luminaire control system of claim 7, wherein the functions are programmable through a programming module in the controlling unit.

9. (canceled)

10. (canceled)

11. The luminaire control system of claim 1, wherein the mobile phone is capable of connecting more than one lighting devices through more than one communication channels at the same time.

12. A method for wirelessly controlling a luminaire by a mobile phone through a user interface generated by an application installed in the mobile phone, comprising:
an initialization process between the luminaire and the mobile phone, comprising:
powering on a the luminaire;
initializing a control process for the luminaire to be ready for remote controlling performed by the mobile phone;
initializing a communication channel between the luminaire and the mobile phone, including performing a frequency matching process and a process of negotiation which dynamically sets parameters of the communication channel established there-between;
a control process directed to the luminaire, comprising:
the luminaire capable of communication protocol translation over the received control signals sent from the mobile phone over the communication channel, wherein the control signals are transferred from input signals generated through the user interface by a user's operation;
the luminaire processing the control signals;
generating one or more control commands by interpreting the control signals; and
in response to the one or more control commands, the luminaire being controlled for performing operations, including driving a lighting unit in the luminaire to operate one or more functions selected through the user interface generated by the application installed in the mobile phone.

13. (canceled)

14. (canceled)

15. The method of claim 12, wherein user interface displays functions to be selected including switching on or off the luminaire, changing colors, adjusting luminosity, controlling frequency of flashing, dimming and transition of the functions.

16. The method of claim 15, wherein the functions are programmable through the user interface.

17. A method for wirelessly controlling a luminaire, comprising:
initializing the luminaire;
initializing a mobile phone;
establishing a communication channel between the luminaire and the mobile phone;
generating input signals through a user interface generated by an application installed in the mobile phone, and transmitted to the luminaire capable of communication protocol translation;
interpreting the input signals and generating control signals;
processing the control signals for generating one or more control commands; and
in response to the one or more control commands, the luminaire being controlled for performing operations, including driving a lighting unit in the luminaire to operate one or more functions selected through the user interface generated by the application installed in the mobile phone.

18. (canceled)

19. The method of claim 17, wherein the application is configured to check if it is required to be upgraded or updated while the mobile phone is initialized.

20. The method of claim 17, wherein user interface displays functions to be selected including switching on or off the luminaire, changing colors, adjusting luminosity, controlling frequency of flashing, dimming and transition of the functions.
